(19) United States
(12) Patent Application Publication
(10) Pub. No.: US 2010/0236638 A1
(43) Pub. Date: Sep. 23, 2010

(54) VALVE CONTROL WHEN REFUELING PRESSURE TANKS

(76) Inventor: Martin Streib, Vaihingen (DE)

Correspondence Address: KENYON & KENYON LLP, ONE BROADWAY, NEW YORK, NY, 10004, US

(21) Appl. No.: 12/733,313

(22) PCT Filed: Jul. 2, 2008
(86) PCT No.: PCT/EP2008/058506

§ 371 Date: May 10, 2010

(30) Foreign Application Priority Data
Aug. 23, 2007 (DE) 10 2007 039 830.3

(51) Int. Cl. F15D 1/00; B65B 3/04

(52) U.S. Cl. 137/14; 141/94

(57) ABSTRACT

A device for capturing a refueling process is described, in which the device has a pressure signal input that is equipped to receive a pressure signal, which reproduces the pressure in a tank; a comparator that is equipped to compare a capturing signal to at least one minimum value; and includes a status output that is connected to the comparator. The status output is equipped to emit a refueling signal when the received capturing signal is more than the minimum value. The refueling signal indicates that the refueling process is taking place. The capturing signal corresponds to the pressure signal and/or the first time derivative of the pressure signal. Also described is a controller, a corresponding control method and the use of a tank pressure sensor, which include each of the features of the device and the method.

### FIELD OF THE INVENTION

The present invention relates to a device and a method for capturing the refueling process of the fuel tank of a motor vehicle, as well as the control of a separating valve that connects the inside of the tank to the surroundings via a charcoal filter.

### BACKGROUND INFORMATION

In order to prevent nasal nuisance, fuel tanks of motor vehicles having an internal combustion engine, particularly hybrid vehicles, are designed as pressure tanks, in which a charcoal filter (AKF) absorbs substances that cause nasal nuisance. In certain types of operation, there is a danger that the charcoal filter is not purged sufficiently and/or leaks. In this connection, an electrically switchable valve is installed between the inside of the tank and the charcoal filter that leads to the surroundings, the switchable valve being closed in the normal state. Such a separating valve is used to separate vapors from the inside of the tank, which are causing a nasal nuisance, from the charcoal filter. By the use of this measure, the charcoal filter clearly has less demand put on it, and, even in the case of small purging quantities, the charcoal filter achieves great efficiency. However, the separating valve has to be open during the entire refueling process, since otherwise the refueling process would be interrupted, and would possibly be stopped automatically by the pumping system.

German patent document DE 19809384 C2 discusses a method for testing the performance reliability of a fuel tank venting system, which includes a comparison of a captured curve over time of at least one operating variable of a test pressure source using a previously determined diagnostic curve, to detect refueling processes. A test pressure is built up, with the assistance of the test pressure source, for instance, a pump, which is evaluated.

According to the related art, the separating valve is opened by the driver when a refueling is planned, and remains open until the driver closes the valve again by hand, after the end of the refueling process.

However, the continuous operation of the separating valve is connected with a high electric power consumption, which puts a load on the vehicle electrical system of the motor vehicle, and leads to a significant discharge of the vehicle electrical system's battery.

### SUMMARY OF THE INVENTION

The exemplary embodiments and/or exemplary methods of the present invention provides for operating the separating valve for a minimum time period and thus reduces the load on the vehicle electrical system. The exemplary embodiments and/or exemplary methods of the present invention provides for activating the separating valve only when this is also actually necessary. Furthermore, with the aid of the exemplary embodiments and/or exemplary methods of the present invention, the separating valve may be closed at the earliest possible time, so as to reduce the current consumption.

In addition, the exemplary embodiments and/or exemplary methods of the present invention provides for capturing or detecting a refueling process with the aid of simple arrangement, that is partially already present in motor vehicles for other purposes, in order to provide the suitable closing time, according to the exemplary embodiments and/or exemplary methods of the present invention, so as to reduce the load on the vehicle's electrical system. Moreover, the exemplary embodiments and/or exemplary methods of the present invention enables controlling the closing state of the separating valve automatically, and thereby offers an effective protection from operating errors, by which the separating valve is closed during the refueling process, and from operating errors by which the separating valve is activated unnecessarily before and/or after the refueling and uses up electrical energy.

According to the exemplary embodiments and/or exemplary methods of the present invention, the separating valve is opened when an actual refueling process is detected, for instance, by the capturing of pressure fluctuations that are typical for the refueling, by the detecting of an open tank lid or by the capturing of additional signals, for instance, automatically generated signals which characterize a refueling process that is in progress. The detecting or the capturing of an actual refueling process may take place automatically. The separating valve may be opened essentially only when a refueling process is detected. In this connection, “essentially” means that, except for refueling processes, the valve is opened only for time periods which are respectively or altogether short, and thus require no substantial electrical energy quantity or power, with reference to the motor vehicle electrical system, by maintenance of the opening state outside a refueling process. The generation of these signals may include the evaluation of sensor data.

According to the exemplary embodiments and/or exemplary methods of the present invention, signals are used for detecting a refueling process, and thus for opening the separating valve, and these signals are yielded automatically and in a direct manner from a refueling process that is in progress, and according to one embodiment of the present invention, these signals being able to be combined with the operation of an appropriate push-button or switch by which the user or driver of the vehicle signals a future or beginning refueling process.

According to the exemplary embodiments and/or exemplary methods of the present invention, the load on the vehicle electrical system by the activation of the separating valve is reduced therefore by using sensor signals or signals derived from these, which characterize the physical process of the refueling, as a trigger signal or tripping device for the actual operation of the separating valve.

The separating valve is provided between a fuel tank and a pressure-compensation chamber. The pressure-compensation chamber may be the surroundings or a line leading to the engine, for instance, the intake manifold of the engine. When the inside of the tank is connected by the separating valve to a line leading to the engine, the intake manifold, for example, the interfering tank gases are combusted at least partially or completely. Furthermore, alternatively or in combination with this, a charcoal filter may be provided between the separating valve and the tank, or between the separating valve and the pressure-compensation chamber.

The separating valve may be provided between a fuel tank and a charcoal filter, via which the fuel tank is connected to the surroundings. Furthermore, the charcoal filter may be positioned on the fresh air side, that is, in connection to the surroundings, which means that the fuel tank is connected to the charcoal filter via a line, the charcoal filter being connected to the surroundings via the separating valve. One or more of these separating valves may be provided in a motor vehicle, at least one of the separating valves opening and closing according to the control method according to the present invention. Therefore, according to the exemplary embodiments and/or exemplary methods of the present invention, at least one separating valve is controlled in such a way that it opens when a sensor has detected a refueling process in an automatic manner, i.e. a manner not dependent on the driver.

As the automatic sensors for detecting a refueling process, numerous sensors may be used which capture at least one physical variable that is characteristic for the refueling process itself, such as variables which permit direct conclusions on the content of the tank, for example, using an optical, an acoustic or an electrocapacitive signal, or using a pressure signal. For this reason, light barriers are suitable as sensors, or devices which capture the optical transmission or reflection, ultrasound sensors which capture the content of the tank, capacitive or resistive sensors which capture the dieelectric properties and the specific resistance of the tank content, pressure sensors which detect a volume increase or a filling process inside the tank via pressure fluctuations or pressure increase, or similar sensors. The sensors may be provided as additional sensors or they may be provided in the form of existing sensors whose signal is already associated with another function of the motor vehicle (such as capturing the tank fuel level or monitoring the tank for fault detection). The capturing of a refueling process may include the logical combination of a plurality of different sensor signals, which may originate with different types of sensors.

To capture such automatic sensor signals, the pressure is captured according to the present invention, which prevails within the tank, it being recognized that a slight overpressure or slight pressure fluctuations go along with the refueling process. The overpressure is created by the gas volume compensation which is brought about by the filling of the tank, and which experiences a flow resistance at the tank opening, especially because of the fuel nozzle and additional openings of the tank, whereby the force of the stream flowing behind it leads to a damming-up of gas and thus to an overpressure in the tank. In the same way, it was realized that the sloshing and pumping motions of the liquid, that go hand in hand with the tank being filled, lead to oscillations in the tank pressure, from which, in turn, one may conclude that there is a refueling process going on. Furthermore, the height of fall of the filling jet leads to oscillations on the surface of the tank's liquid content. For this reason, the pressure in the tank itself is observed for one thing, or in combination with the first derivative with respect to time of the pressure, which is used as a measure for the oscillations.

To implement the exemplary embodiments and/or exemplary methods of the present invention, a pressure sensor provided in the tank may be used, which is either fastened to the floor of the tank or which may be to the ceiling of the tank, and which accordingly captures either the liquid pressure at the floor of the tank or the gas pressure and air pressure at the ceiling of the tank, or rather, in the gaseous space above the liquid. In particular, the pressure sensor may be used for this which is provided at the same time in pressure tank systems for diagnostic reasons, so that systems that already exist, do not have to be furnished with any additional pressure sensor. Using this sensor, refueling processes may be captured, based on which the separating valve is opened, according to the present invention.

In particular, it was recognized that the beginning of the refueling goes hand in hand with a sudden, slight pressure increase, so that especially the combination of the derivative of the pressure with respect to time and the pressure itself are captured, particularly by determining whether a sudden increase has taken place, which transits to a slight, essentially constant overpressure. For this reason, the pressure may be compared to a minimum value which is greater than a value which is also exceeded in the case of measuring noise, ambient noise or further fault causes during the pressure measurement, which, however, is less than a value that comes about during refueling, that is, even during refueling processes having slow fuel supply and low flow resistance for the gas exchange, and thus a low overpressure. Moreover, the increase, that is, the first time derivative of the pressure signal, may be compared to a typical pressure increase rate that is also above a protective distance. According to the exemplary embodiments and/or exemplary methods of the present invention, the pressure signal is basically investigated with respect to a low, static overpressure and/or with respect to a pressure increase that is typical for a start of refueling. To do this, the pressure signal or the current slope of the pressure signal, i.e. the first time derivative, is compared to a minimum value. Furthermore, both variables may also be compared to a corresponding minimum value. Each individual one of these comparisons supplies a signal that indicates that a refueling is taking place, these signals, however, also being able to be combined, to increase the fault tolerance.

The device according to the present invention, besides the control of the separating valve, therefore includes a pressure signal input, which cooperates with an external pressure sensor, for instance, the pressure sensor of a tank that is provided anyway for diagnostic purposes, in order to receive a pressure signal from it. This pressure is either compared itself, and/or its first time derivative, to a respective minimum value. Therefore, the device may include a comparator, which compares the pressure signal, the first time derivative or both to the respective minimum value. As the capturing signal that is used to capture the refueling process, the pressure signal is therefore used and/or the first time derivative of the pressure signal. The device also may include a differentiation device, which generates the first time derivative of the pressure signal from the pressure signal, especially when the latter is evaluated. The corresponding capturing signal (i.e. the pressure signal and/or the first time derivative of the pressure signal) is supplied to the comparator, which in turn outputs the refueling signal via a status output. The status output may be included in the device and or the comparator. The minimum value may be supplied to the device via an additional minimum value input, or it may be stored in the device. A typical curve shape for the pressure characteristic may generally be used during refueling for the comparison. The use of a pressure threshold value, that is, a minimum value, represents a curve feature that is particularly simple to check. The device may also include additional computing units which compute the minimum value from auxiliary input signals.

The minimum value may be constant, or it may also generally represent a curve shape which is typical for the pressure characteristic or for the shape of the first time derivative of the pressure signal, this typical characteristic being compared to the actually captured pressure signal characteristic or characteristic of the first time derivative of the captured pressure signal. The minimum value compared according to the present invention may thus also be a part of a typical curve shape, or a feature or property of a typical refueling pressure curve characteristic. The comparator may consequently be a simple comparator for a single instantaneous value, or, in the case of a curve shape to be compared, it may also be a correlator or matched filter which, when it detects the typical curve shape, emits a correspondence signal or a correlation signal. One or more typical pressure characteristics may be checked, the typical pressure characteristics including: the pressure characteristic at the beginning of refueling, the pressure characteristic at the end of refueling and the pressure characteristics caused by fluctuations which are to be attributed to pumping processes and/or sloshing motions that are typical for a fueling process that is taking place.

The evaluation of the pressure signal by a comparator may also include the checking of the exceeding of a maximum value, in order thus to exclude systemic faults and to detect erroneously reported refueling processes. Such maximum values may be values that are above pressure values which are not even reached at high flow rates and high flow resistance at the tank opening.

Furthermore, the capturing according to the exemplary embodiments and/or exemplary methods of the present invention may take into account the operating of a refueling command switch. Such a refueling command switch is operated before refueling, and it indicates that, in the subsequent time period, the start of a refueling process is to be expected. Instead of opening the separating valve immediately when operating the refueling command switch, the separating valve may be opened only when, besides the venting signal provided by the operation of the refueling command switch, there is also present the comparison signal or the status signal of the comparator, according to which a refueling process is also taking place based on the pressure signal.

Therefore, the device according to the present invention includes a logic circuit, between the status output that emits the refueling signal, on account of which the separating valve is switched, and the comparator, and this logic circuit combines the venting signal emitted by the refueling command switch with the results of the comparator. The device may include a time circuit which emits an active signal for a time period that begins with the operation of the refueling command switch and ends after a predetermined time duration. The device according to the present invention is then active during this time period, and opens the separating valve upon detecting the beginning of the refueling process. Consequently, it is excluded that the separating valve is opened by mistake if, erroneously for example, a refueling process is detected by a strong pressure fluctuation or a reading error.

Moreover, a second time interval may be specified that begins with the capturing of a refueling process (in which the capturing signal exceeds the at least one minimum value), and which lasts for another time period during which a refueling signal is emitted. Because of this, the separating valve is able to remain open, even if the capturing signal drops briefly below the minimum value, during the refueling process.

Finally, a minimum time duration may be introduced for which the capturing signal is continuously above the minimum value, in order to filter out brief pressure peaks, which do not correspond to any actual refueling process, in order to emit the refueling signal only when it is assured that the capturing signal has already been above the minimum value for the minimum time period. The minimum time period corresponds to the mechanism of contact debouncing, as is known from push-button switches.

Besides the time-related filtering or the time-related protective intervals, protective spacings for pressure values may also be introduced which are between a normal value and a threshold value. Examples of a normal value are the minimum value on which the comparison is based, the minimum value in the case of the pressure signal corresponding to a minimum pressure, and in the case of the first time derivative of the pressure signal corresponding to a pressure reduction rate of ca. 0. As has already been commented upon, in order to avoid false refueling signals, a protective distance is selected so that even noise or small interferences during the measurement of the pressure, or additional interferences are tolerated, without a refueling signal being emitted falsely. The threshold value actually drawn upon for the comparison therefore may be between a value equal to the normal state+the protective distance, which avoids a false capturing of a refueling command process conditioned upon noise or error, and the quantity of a capturing signal as it appears in response to low excitations (low flow resistance, low fuel throughput or low oscillations of the liquid). The protective distance may be computed from given fault tolerances and noise of the sensor and the measuring device to which the sensor is connected, and a further increase which also takes into account wide fluctuations, for instance, due to structure-borne noise. A pressure sensor may be used that has an appropriate resolution and generates a low noise power. Furthermore, the pressure sensor may be provided having an accuracy that makes possible the distinction described.

The pressure may be reflected by a pressure signal which is analog, discrete in time and/or value, and which makes possible a sufficient resolution and accuracy for the distinction described above.

The pressure and the pressure signal may be provided by tapping a pressure sensor that is already fastened to the tank, or by branching off the pressure signal during the processing of the pressure signal. The use of the method according to the present invention, as well as the device, is made in combination with a hybrid drive. The exemplary embodiments and/or exemplary methods of the present invention may also be used in combination with drive systems which include high-pressure supercharging, dethrottling (EHVS, EMVS, valvetronic, high-AGR, lean operation as well as additional consumption concepts having smaller purge quantities). In order to achieve the suitable precision, pressure sensors that are already present may also be exchanged, which are then applied to a device or according to the method according to the present invention, and which carry out the originally provided function at the same time.

The device features used in the description and in the claims, that is, pressure signal input, comparator, status output, differentiation device, input for venting signal and logic circuit, may be implemented using discrete components, integrated components in analog or digital circuit technology or in a combination of these, as well as using a microprocessor, program code and the appropriate interfaces. The signals used may be voltage signals and may also be digital or analog. The device features are able to be implemented using an interface of a processor and using appropriate associated software. A power output stage may be connected to the interface which supplies the separating valve with electric power when it is to be opened.

Exemplary embodiments of the present invention are shown in the drawings and explained in greater detail in the following description.

### BRIEF DESCRIPTION OF THE DRAWINGS

FIG. 1 shows a system for explaining the inventive concept on which the present invention is based.

FIG. 2 shows a typical curve of a pressure signal for explaining the concept on which the present invention is based.

FIG. 3 shows a circuit diagram of a device according to the present invention.

### DETAILED DESCRIPTION

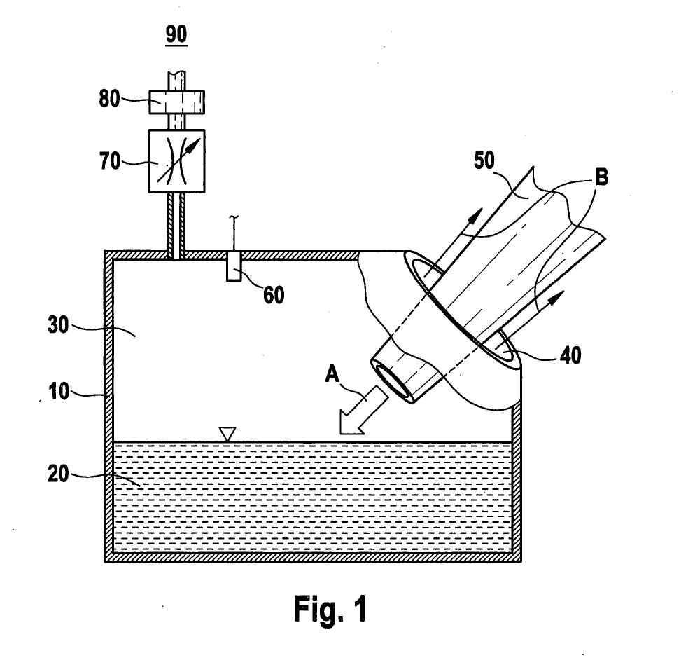

FIG. 1 shows a system used to explain the concept on which the exemplary embodiments and/or exemplary methods of the present invention is based. FIG. 1 shows a tank 10, in which liquid fuel 20 is provided, as well as a gas mixture 30 (air/fuel vapors) that lies over it. Through opening 40, that is not shown to scale and is shown only sketchily, fuel is introduced into the inside of tank 10 at a first flow A, through a filler neck 50. In order to compensate for the added volume, a gas equalization flow B comes about, which experiences a flow resistance through opening 40 and filler neck 50, which reduces the opening required for flow B. It is obvious that a slight overpressure builds up inside tank 10, and especially inside the gas mixture, by the flow resistance of flow B. In other words, there comes about a disequilibrium between flows A and B, whose strength is given by the quantity flow rate or the volume flow rate of flow A and the flow resistance for flow B. Furthermore, the surface of fuel 20 executes movements which are generated by the fuel flow through flow A.

A pressure sensor 60 is situated on the ceiling of tank 10, which picks up the pressure of gas volume 30. The pressure sensor converts the pressure to a pressure signal, which is able to be evaluated. The inside of tank 10 is also connected to a separating valve 70, which, in an electrically controllable manner, separates the inside of tank 10 from a charcoal filter 80, which in turn connects separating valve 70 to the surroundings 90. According to one exemplary embodiment of the present invention, the pressure is captured via sensor 60, evaluated using a circuit according to the present invention, which, in turn, activates separating valve 70 appropriately. Therefore, separating valve 70 may have an electrical control input, via which the opening state of separating valve 70 is able to be set. Without activation, separating valve 70 may be closed and it opens when an appropriate current is present, for instance, on an actuator coil which causes the mechanical opening.

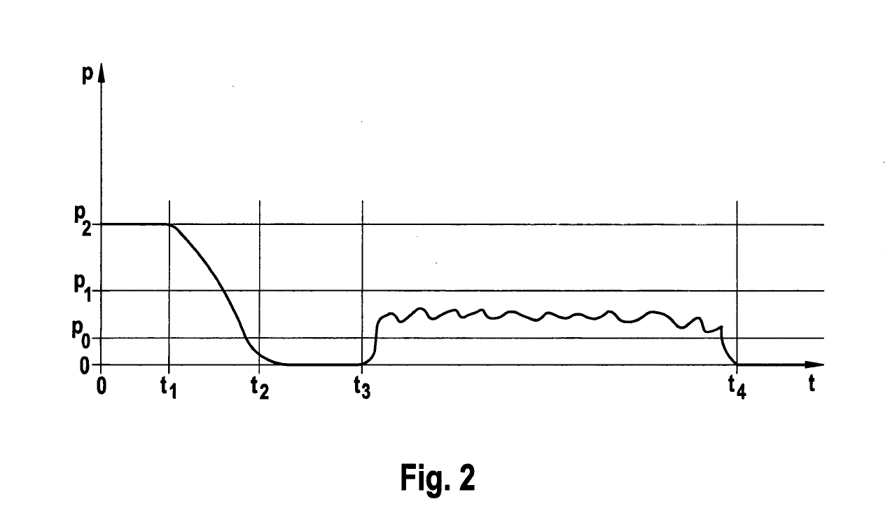

FIG. 2 shows the curve of a pressure signal, as is able to be captured by pressure sensor 60 of FIG. 1. Between times 0 and t₁ an overpressure prevails in the tank, which is able to be reduced by opening the separating valve. At time t₁, the separating valve or another compensating valve or compensating opening is opened in order to adjust the pressure from overpressure p₂ to 0. The tank opening is opened, for example, at time t₂, in order to introduce a filler pipe. No refueling takes place between times t₂ and t₃. However, at a time between t₂ and t₃, for instance at time t₂, the user of the vehicle to which the tank belongs may already be operating a refueling command switch which, according to the related art, would immediately open the separating valve and hold it in the open state. However, the opening is only necessary if the refueling state actually takes place, so that the electric power, that is used to open the tank between times t₂ and t₃, puts a load on the vehicle electrical system without further benefit.

According to the exemplary embodiments and/or exemplary methods of the present invention, the device according to the present invention and the method according to the present invention detect, between times t₂ and t₃, that no refueling process is taking place, and that consequently the separating valve may remain closed.

According to one specific embodiment of the present invention, the large pressure drop between p₂ and 0 is captured, which comes about because of a one-time volume adjustment, the capturing of this adjustment being taken as the condition for the later opening of the separating valve. In other words, the device according to the present invention and the method according to the present invention do not emit a refueling signal if no such pressure drop was detected between t₁ and t₂. Alternatively, one may also capture high pressure value p₂ and compare it to a pressure value captured later, for instance, a pressure value which is captured in time period t₂ to t₃, in order thus to detect the pressure drop between t₁ and t₂. The detection of the pressure drop from p₂ to 0 may replace the tank venting signal, which comes about by the operation of a refueling command switch, or may be logically combined with it, for instance, by a logical AND operation or a logical OR operation. Furthermore, protective time intervals may be provided, as were described above, in connection with the capturing signal.

The refueling process begins at time t₃, so that the filling (compare FIG. 1, flow A) leads to an increasing liquid volume in the tank. For the pressure compensation, a gas flow therefore comes about from the inside of the tank (compare FIG. 1, flow B) which is limited by various geometric factors, such as the tank opening, the filler pipe, etc. Since the compensation gas volume is not able to exit completely unhindered, a slight overpressure comes about which, in the time period between t₃ and t₄, manifests itself as an overpressure between p₀ and p₁, where p₀ corresponds to a pressure which occurs even at low fuel supply and low flow resistance of flow B, and forms a minimum threshold value. Pressure value p₁ corresponds to a threshold value which is not achieved, even in the case of a strong fuel supply, that is, at a high volume throughput rate of the fuel and in the case of a strong resistance of flow B. The exceeding of value p₁ may therefore be interpreted as the occurrence of a capturing error, so that the exceeding of threshold value p₁ leads to no refueling signal being emitted, although the value is also greater than p₀. Moreover, a fault signal may be emitted in addition.

The first time derivative of the pressure signal is also investigated according to the present invention, which is not constant between times t₃ and t₄ because of pressure fluctuations. The absolute quantity of the first derivative may be used so as to be able also to compare negative pressure increases to a minimum value. According to one special embodiment of the present invention, the first time derivative of the pressure signal is squared for this. The dispersion of the pressure signal thus obtained reflects the vibrations of the water surface, flows and turbulences because of flow A, as well as flows and turbulences of flows B, which are directly linked to the refueling process. Therefore one is able also to draw conclusions as to the presence of a refueling process from the first time derivative of the pressure signal.

Furthermore, the first time derivative of the pressure signal may be combined with the pressure signal, which is compared in each case to a respective minimum value. An AND operation or an OR operation may be used as the logical combination. Besides the direct comparison of the pressure signal and the derivative of the pressure signal, one may also observe a certain curve shape of the curve of the pressure signal, for instance, the rise in pressure shortly after time t₃ to a special value. For this reason, according to the present invention, one may generally also investigate the captured pressure signal with respect to the occurrence of a special side shape that is defined by the slope and the height. Both slope and height are to be distinguished from other causes specifically for a refueling process. In the same way, one may also investigate the side that comes about shortly before time t₄ by the switching off of the refueling current. Beyond that, according to the exemplary embodiments and/or exemplary methods of the present invention, besides the first time derivative of the pressure signal, one may also have a look at frequency analyses of the pressure signal, for instance, using an FFT analysis, since the alternating component of the pressure fluctuation between time t₃ and t₄ is specific for the fuel flowing into the tank, and the pressure variations in connection with this. Especially using a frequency transformation, the pressure changes which come about because of refueling, differ from other pressure fluctuations. The first derivative of the pressure signal may be formed, according to the present invention, using a high-pass, for instance, a high-pass of the first order (for example, an LR network or an RC network) in an analogous manner or using a digital differentiator.

According to one additional embodiment of the present invention, after time t₃ there comes about a protective interval, so that the refueling signal is given up as of time t₃ during the protective interval, even when the capturing signal falls below the respective minimum value after time t₃, during the protective interval. In the same way, a protective interval may follow time t₄, so that, in spite of the capturing signal, a refueling signal is emitted below the minimum value for the protective interval, in order not to impair short-time falling below or shortly subsequent fueling processes. The pressure signal and its time derivative may be averaged, moreover, or smoothed over a running time window, during which the maximum value within the time window is considered to be the capturing signal. By doing this, short time fueling interruptions are caught, whereby an additional off/on switching process of the separating valve is avoided. Furthermore, the pressure signal and the first time derivative of the pressure signal may be linked, not only logically but also arithmetically, for example, via a weighted addition.

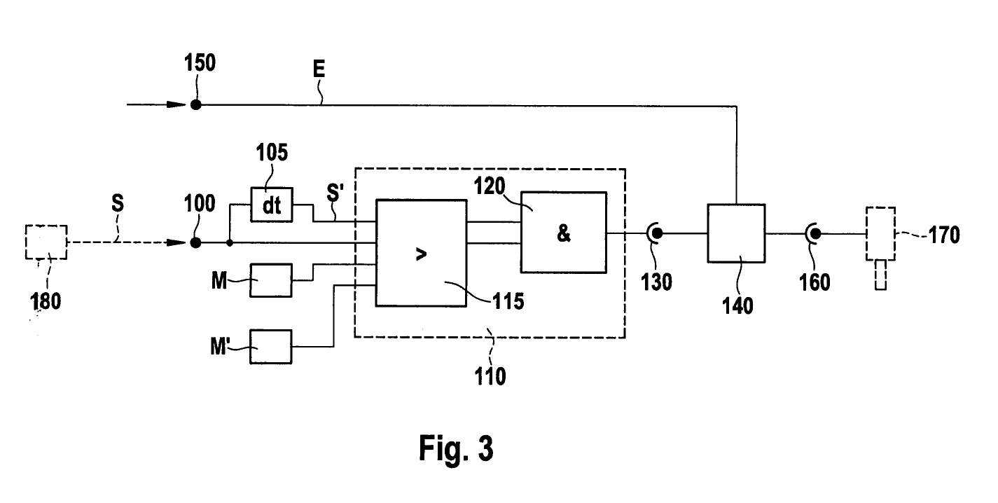

FIG. 3 shows a circuit configuration of a device according to the present invention. The device includes a pressure signal input 100 which is equipped to receive a pressure signal S. Pressure signal S may originate from a pressure sensor (shown as a dashed line) or may be branched off from a pressure evaluation device, which is used for diagnostic purposes. Moreover, S may originate with the tapping of a pressure signal line. The device of FIG. 3 also includes a comparator 110, which compares a pressure signal to a minimum value. In the device shown in FIG. 3, a two-part capture signal is evaluated by comparator 110, and it corresponds to pressure signal S as well as its derivative S′. Therefore, the comparator includes respectively one input for a pressure signal S and for its time derivative S′. The comparator also includes a first minimum value M as well as a second minimum value M′, the comparator being equipped to compare pressure signal S to value M and to compare the derived pressure signal S′ to minimum value M′. As a result, comparator 110 includes two further inputs, respectively for M and for M′. In one embodiment that is not shown, the minimum values are provided in comparator 110 itself. In a first stage 115, comparator 110 first outputs two comparison results via two comparison outputs, which are evaluated by an evaluation circuit 120.

Evaluation circuit 120 links the two comparison results to form one refueling signal, which is output at a refueling signal output 130. Instead of an AND operation of comparison results 120, one may also select an arithmetic linkage, as was mentioned above. The output refueling signal is binary and is passed on to a logic circuit 140 that is postconnected to the comparator. Logic circuit 140 also processes tank vent signal E, which is input via a tank vent signal input 150. The tank vent signal input may be connected to a refueling command push-button, which produces a vent signal. The logic circuit passes on the refueling signal, which is present at input 130, and which may be only when, in addition, a capturing signal E is also present at the logic circuit. In addition, logic circuit 140 is able to include time switches which filter the refueling signal at output 130 and/or the tank vent system with respect to time, in order thus to provide protective intervals. The logic circuit also includes an output 160, via which a control signal is emitted, the separating valve being connected to output 160 and being controlled by the control signal. The separating valve may be configured as a break contact, so that for an open switching state the separating valve is continuously provided with current. A separating valve is connected at the control output of logic circuit 140, as is shown under reference symbol 70 in FIG. 1. Separating valve 170 (shown in dashed lines), according to the control signal of logic circuit 140, opens the line between charcoal filter 80, which leads to the surroundings, and the inside of the tank.

Between the pressure sensor (shown in dashed lines) and pressure signal input 100 an analog/digital converter circuit may be provided, in this case, comparator 115 does not compare any analog signals, but rather digital signals. Comparator arrangement 110, whose components as well as logic circuit 140 may be provided as a microprocessor, an analog/digital converter provided between pressure sensor 180 and pressure signal input 100 being able to be provided in the same processor. Furthermore, the elements shown in FIG. 3 may be implemented as a software/hardware combination having an appropriate processor, on which the software runs, the software implementing the method and the device, and the processor also includes inputs, outputs and interfaces which provide the inputs and outputs of the circuit of FIG. 3. To control the separating valve, a power output stage may be provided that is controlled via software or a logic signal.

According to one embodiment of the present invention, a device is provided for capturing a refueling process, which includes a pressure signal input 100, that is equipped to receive a pressure signal that reflects the pressure in a tank; a comparator 110, which is equipped to compare a capturing signal having at least one minimum value M; and a status output 130 which is connected to comparator 110 and is equipped to output a refueling signal when the capturing signal received is more than minimum value M, the refueling signal stating that the refueling process is taking place, and the capturing signal corresponds to pressure signal S and/or the first time derivative of pressure signal S′. Moreover, such a device may be provided with a differentiating device 105, which is equipped to provide the first time derivative of pressure signal S′, starting from pressure signal S, the differentiation device being connected to comparator 110, so as to supply it with the first time derivative of pressure signal S′, and the differentiation device is connected to pressure signal input 100 in order to be supplied by it with pressure signal S. In this instance, minimum value M, which is provided to be compared to the pressure signal, which may correspond to a minimum pressure, which is above the normal pressure by a protective distance, but is smaller than pressure p₀, which comes about minimally in the tank by filling the tank with liquid and by venting-volume compensations, and/or an additional one of the minimum values, which is provided to be compared to the time derivative of the pressure signal, corresponding to a minimum pressure fluctuation, which is greater than zero by a protective distance, but is smaller than a pressure fluctuation which minimally comes about during the filling of the tank or at the beginning of the filling of the tank.

This embodiment of the present invention also may include a venting sign input 150 for a venting signal which indicates that the pressure compensation between tank and the surroundings has taken place, the device also including a logic circuit 140 provided between the comparator and the status output, which emits the refueling signal only when the capturing signal received is more than the minimum value and the venting signal is present.

According to one implementation of the present invention, the method for capturing a refueling process of a tank, according to the present invention, includes the steps: capturing a pressure p that prevails in the tank, comparing a capturing signal S, S′ to at least one minimum value, the capturing signal corresponding to the captured pressure and/or the first time derivative of the captured pressure; and outputting a refueling signal when the capturing signal is above the minimum value, the refueling signal stating that the refueling process is taking place.

In one embodiment of the method, minimum value p₀, to which the capturing signal is compared, corresponds to the minimum pressure which is higher than the normal pressure by a protective distance, but lower than a pressure which minimally comes about by filling the tank with liquid and by venting-volume compensation in the tank, and/or an additional one of the minimum values, which is compared to the derivative of the pressure signal with respect to time, corresponding to a minimum pressure fluctuation which is greater than zero by a protective distance, but is smaller than a pressure fluctuation which comes about minimally during the filling of the tank or at the beginning of the filling of the tank.

Furthermore, the method according to the present invention may include the capturing of a venting signal which indicates that a pressure equalization has taken place between the tank and the surroundings, the refueling signal being output only if the capturing signal received is greater than the minimum value p₀ and the venting signal is present.

The exemplary embodiments and/or exemplary methods of the present invention may be implemented by using a tank pressure sensor for capturing a refueling process by controlling a separating valve upon capturing the refueling process.

1-8. (canceled)

9. A controller for a separating valve, which is provided for controlling the pressure in a tank, comprising:
a control output that is connectable to the separating valve, and which is equipped to output an opening signal by which an opening state of the separating valve is controllable; and
a device to detect a refueling process;
wherein the controller is equipped to output the opening signal when the capturing device outputs the refueling signal, and wherein the tank is connected to a pressure compensation chamber via the separating valve.

10. The controller of claim 9, wherein the separating valve is situated one of (i) between the tank and a charcoal filter, and (ii) between the charcoal filter and a pressure compensation chamber.

11. The controller of claim 9, wherein the capturing device has an input for sensor signals, wherein the sensor signals reproduce at least one pressure value that prevails in the tank, wherein the capturing device includes a comparator to compare the pressure value to a threshold value, and wherein the capturing device is equipped to output a refueling signal when a pressure value is captured that is greater than a threshold value.

12. The controller of claim 9, wherein the controller also includes a logic circuit that logically links a venting signal or a refueling command signal, which is generated by operating a switch or a push-button, to the refueling signal, and outputs the opening signal as a result of the logical linkage.

13. A control method for controlling an opening state of a separating valve, the method comprising:
capturing a present refueling process, wherein the separating valve controls a pressure in a tank; and
opening the separating valve if a refueling process has been detected, the tank being connected to a pressure compensation chamber via the separating valve.

14. The control method of claim 13, wherein the separating valve is situated one of (i) between the tank and a charcoal filter, and (ii) between the charcoal filter and a pressure compensation chamber.

15. The control method of claim 13, wherein the capturing is an automatic capturing and includes an evaluation of a pressure signal, which reproduces the pressure in a tank volume, and wherein the evaluation includes a comparison of at least one of a pressure signal and a first time derivative of the pressure signal to a threshold value.

16. The control method of claim 13, wherein the control method logically links at least one of a venting signal and a refueling command signal, which is generated by operating one of a switch and a push-button, to the refueling signal, and outputs the opening signal as a result of the logical linkage.
